(19) United States
(12) Patent Application Publication
(10) Pub. No.: US 2026/0283062 A1
(43) Pub. Date: Sep. 24, 2026

(54) SOIL WORKING DEVICE

(71) Applicant: Grimme Landmaschinenfabrik SE & Co. KG, Damme (DE)

(72) Inventor: Eike Bohlen, Dötlingen (DE)

(21) Appl. No.: 19/469,772

(22) PCT Filed: Mar. 22, 2024
(86) PCT No.: PCT/EP2024/057841

§ 371 Date: Sep. 26, 2025

(30) Foreign Application Priority Data
Mar. 27, 2023 (DE) 20 2023 101 530.1

(51) Int. Cl. A01B 15/18; A01C 5/06

(52) U.S. Cl. CPC A01B 15/18; A01C 5/062

(57) ABSTRACT

A soil tillage device includes a frame device, and a coulter unit detachably attached to the frame device and which, during operation, is moved through the ground to create a furrow. The frame device and the coulter unit each have at least one first recess extending transverse to the working direction. The first recesses of the frame device and coulter unit are aligned about a first recess center axis, and a first fastening element extends through the first recesses. The frame device or the coulter unit has at least one second recess extending in the transverse direction with a second recess center axis, through which a second fastening element extends and which is formed open to the outside in a longitudinal section in an insertion direction. In the longitudinal section the insertion direction is angled at right angles to an auxiliary straight line through the two recess center axes.

### CROSS REFERENCE

This application claims priority to PCT Application No. PCT/EP2024/057841, filed Mar. 22, 2024, which itself claims priority to German Patent Application No. 20 2023 101530.1, filed Mar. 27, 2023, the entireties of both of which are hereby incorporated by reference.

### FIELD OF THE INVENTION

The invention relates to a soil tillage device. The soil tillage device comprises a frame device and a coulter unit. The coulter unit is detachably attached to the frame device and can be moved through the soil in a working direction during operation to create a furrow. The frame device and the coulter unit each have at least one first recess which is formed continuously in a transverse direction angled to the working direction. The first recess of the frame device is aligned with the first recess of the coulter unit about a first recess center axis. A first fastening element extends through the first recesses. The frame device or the coulter unit has at least one second recess which is continuous in the transverse direction and has a second recess center axis. A second fastening element extends through the second recess. In a longitudinal section the second recess is formed open to the outside in one insertion direction.

### BACKGROUND OF THE INVENTION

Soil tillage devices are known. In this case, the coulter unit is to be pivoted about the first recess center axis for mounting on the frame device, while the first fastening element is arranged in the first recesses. This allows the second fastening element to be guided into the second recess. The second fastening element creates a force-fit connection between the coulter unit and the frame device. The open second recess is advantageous because it facilitates the assembly and disassembly of the coulter unit in that it no longer requires the complete removal of the second fastening element from the second recess in the transverse direction. A disadvantage of the known soil tillage device is the lack of reliability of the fastening of the coulter unit to the frame device, since the coulter unit pivots back around the first recess center axis despite the power flow, in particular in rough operating conditions.

### BRIEF SUMMARY OF THE INVENTION

The object of the present invention is to provide a generic soil tillage device whose coulter unit is reliably fixed to the frame device.

According to the invention, the object is solved in that in the longitudinal section the insertion direction is angled to a tangential direction which is oriented at right angles to an auxiliary straight line through the two recess center axes. This means that in the longitudinal section the insertion direction is angled by less than 90° to a radial line relative to the first recess center axis, which intersects the second recess center axis.

This design of the second recess means that the coulter unit cannot pivot around the first recess center axis independently of any frictional connection as long as the fastening elements extend through the respective recesses. The design according to the invention retains the advantages of the second recess open to the outside and, with the aid of the fastening elements, in particular in the area of the second recess, preferably at least radially to the first recess center axis, a form-fit between the coulter unit and the frame device is achieved. This results in a significantly more reliable fastening of the coulter unit to the frame device.

The soil tillage device according to the invention is to be mounted in such a way that the coulter unit is initially moved in the insertion direction or against the insertion direction towards the frame device until the second recess center axis coincides with a center axis of the second fastening element. The coulter unit is then pivoted around the second recess center axis until the first recesses are aligned with the first recess center axis. The first fastening element is then inserted into the first recesses in the transverse direction.

The soil tillage device according to the invention is in particular an agricultural machine. The coulter unit is designed in particular as a coulter. The coulter unit is designed to be mirror-symmetrical in particular. The coulter unit is used for lateral displacement of the soil. The recesses are preferably arranged above the soil surface during operation.

The frame device and/or the coulter unit is/are in particular designed as one or more parts. The frame device and/or the coulter unit is/are preferably rigid, particularly preferably made of steel. A cutting plane of the longitudinal section is preferably arranged parallel to the working direction and vertically. A cutting plane of a cross section is preferably arranged parallel to the transverse direction and vertically. The transverse direction is oriented at right angles to the working direction in particular.

The second recess is designed in particular to be open to the outside in such a way that the second fastening element can move relative to the coulter unit or to the frame device only in the insertion direction, apart from the transverse direction. In the longitudinal section, the second recess is designed in particular in a U-shape. Preferably, the second recess is designed, inter alia, by opposing respective borders of the coulter unit or the frame device, which are parallel to the insertion direction and whose distance in particular corresponds at least substantially to a diameter of the second fastening element, wherein a clearance fit is preferably provided. The open second recess preferably allows the coulter unit to be inserted, hooked in or hooked up and then pivoted on the frame device before the first fastening element is inserted into the first recesses.

Preferably, in particular in cross-section, at least part of the coulter unit is located between two parts of the frame device or at least part of the frame device is located between two parts of the coulter unit. The coulter unit comprises in particular a coulter body preferably made of cast metal with a coulter tip and two sheet metal elements fixedly arranged on the coulter body, which are in detachable contact with the frame device. The sheet metal elements extend flat at right angles to the transverse direction.

Preferably, the coulter unit has the second recess. The coulter unit preferably has two second recesses and/or two first recesses, which are arranged in particular offset to one another in the transverse direction, wherein in particular each of the sheet metal elements has a first and a second recess.

Preferably, the insertion direction is oriented at least partially away from the first recess center axis. This means that the insertion direction coincides at least partially with a direction parallel to the auxiliary straight line which direction points away from the first recess center axis. This facilitates assembly in that the second fastening element does not have to be grasped from the inside with the second recess during assembly, but in particular the coulter unit can be pushed directly from the outside against the second fastening element before the first recesses are pivoted one over the other.

Preferably, the second recess is arranged in front of the first recesses with respect to the working direction. The second recess is preferably designed such that, during operation, it is spaced further from the ground than the first recesses. This reduces the risk of soil thrown up by the coulter unit wearing down the second recess, in particular its borders, which are important for fastening the coulter unit. The second recess center axis is preferably equally spaced from both borders and a recess base of the second recess, which is located furthest inside the coulter unit or the frame device. The recess base is in particular designed in a semicircular shape in the longitudinal section. The second recess center axis coincides in particular with a longitudinal central axis of the second fastening element.

Preferably, in the longitudinal section the insertion direction is angled in a longitudinal section by an angle to the tangential direction which is at least 30°, preferably at least 50°, particularly preferably at least 70°. This ensures that even if there is a certain amount of play between the second fastening element and the second recess, only minimal pivoting of the coulter unit relative to the frame device about the first recess center axis is possible.

The first recesses are in particular through holes. The first recesses are preferably completely enclosed by the frame device or the coulter unit. The first recesses are in particular round in longitudinal sections through the frame device or the coulter unit, wherein the first recess center axis runs through the center point of the recesses and corresponds to their axis of symmetry. Alternatively, at least one of the first recesses is optionally designed to be open to the outside, wherein its insertion direction preferably deviates from the insertion direction of the second recess.

The first fastening element is preferably designed to be movable relative to the coulter unit and/or movable relative to the frame device. The first fastening element preferably has a clearance fit within the first recesses. The first fastening element is preferably formed as a screw. The advantage is that in addition to the form-fit, a frictional connection between the coulter unit and the frame device is also achieved. As an alternative to the screw, the first fastening element is preferably formed as a bolt or pin, in particular with an axial lock.

The coulter unit or the frame device preferably has a second recess which is aligned with the second recess of the frame device or coulter unit around the second recess center axis and which is continuous in the transverse direction. Thus, both the coulter unit and the frame device each have a second recess, wherein the second recesses are aligned similarly to the first recesses. Contrary to the second recess of the frame device or coulter unit, the second recess of the coulter unit or frame device is preferably completely enclosed, in particular like the first recesses. The second fastening element extends through the second recesses. The second fastening element is preferably designed to be movable in the transverse direction relative to the coulter unit and relative to the frame device. In particular, the second fastening element is designed as a screw. Even if the second fastening element is removed from the second recesses, it can remain in the second recess of the coulter unit or the frame device during assembly or disassembly of the coulter unit due to the open design of the second recess of the frame device or coulter unit. Alternatively, the second fastening element is enclosed by the coulter unit or frame device, thereby reducing the number of parts that can move relative to each other.

The frame device comprises in particular a one-piece frame element, in particular in the form of a cast part. The first recess of the frame device and the second recess of the frame device are preferably formed in the frame element. Because both recesses are formed in the same component of the frame device, they can be positioned more precisely relative to each other, resulting in a more resilient connection between the coulter unit and the frame device.

Preferably, the soil tillage device comprises a first cover element which, in particular with reference to the working direction, rests laterally against the coulter unit or the frame device. The first cover element preferably has a first recess into or through which the first fastening element extends. Particularly preferably, the first cover element has a second recess into or through which the second fastening element extends. The first recess and/or the second recess of the first cover element preferably has/have an internal thread. The first cover element enables a large-area axial force to be applied to the frame device or the coulter unit. The internal thread also eliminates the need for nuts for the fastening elements, which are preferably formed as screws. In particular, the first cover element allows disassembly of the coulter unit, in particular removal of the first fastening element, with only a single wrench and without any other tools.

Preferably, the soil tillage device has a second cover element which rests laterally against the coulter unit or the frame device opposite the first cover element. The second cover element has a first recess through which the first fastening element extends. The second cover element has in particular a recess through which the second fastening element extends. In particular, screw heads of the fastening elements rest against a lateral surface of the second cover element, wherein the fastening elements have a clearance fit within the second cover element. The second cover element is located opposite the first cover element in particular in that at least part of the coulter unit and at least part of the frame device are arranged between the cover elements. The second cover element also enables axial forces to be applied over a larger area into the connection area between the coulter unit and the frame device. At least one of the fastening elements and the second cover element can optionally be designed in one piece.

The first cover element and/or the second cover element has/have, in a side view or in a longitudinal section, a substantially arcuate underside and/or a substantially arcuate upper side. In particular, the cover elements have an at least substantially identical geometry, at least apart from their recesses. The arcuate form is to be understood in particular as an arcuate form around an axis parallel to the transverse direction. The arcuate underside allows for an advantageous guidance and removal of earth thrown up by the coulter unit. The arcuate upper side allows a space-saving insertion of a singling wheel of an optional singling device for seeds included in the soil tillage device. In the side view or in the longitudinal section, the underside and the upper side run towards each other in the opposite direction to the working direction. The recesses of the cover element are in particular both arranged in a front half of the cover element.

The soil tillage device preferably comprises a retaining element which is enclosed by the frame device. The retaining element extends particularly preferably into or through the frame element. Preferably, the retaining element extends in the transverse direction into or through the first cover element and/or the second cover element. The retaining element is in particular stationary relative to the frame element and movable at least in the transverse direction relative to the at least one cover element. The retaining element is in particular a dowel pin that is inserted into the frame element in a force-fitting or form-fitting manner. The retaining element serves to hold the at least one cover element in its intended position even when at least one of the fastening elements has been removed from the respective recesses. The retaining element thus simplifies the assembly and disassembly of the coulter unit.

Preferably, the frame device comprises a stop element. The stop element is positioned in particular such that the first recesses are aligned when the second recesses are aligned and the stop element is in contact with the coulter unit. The coulter unit preferably has an outwardly open recess into which the stop element can be inserted. The stop element is particularly preferably designed as one piece with the retaining element.

Preferably, the soil tillage device comprises a sowing device. The sowing device preferably comprises a container for storing seeds and a singling device for singling the seeds. In addition, the singling device is particularly preferably used for depositing the seeds in the furrow, in particular through between the sheet metal elements. The upper side of the cover elements extends in particular in an arcuate manner around a rotation axis of a singling wheel of the singling device. In particular, the soil tillage device according to the invention is thus a seed drill.

The invention is furthermore solved by an agricultural machine with a plurality of soil tillage devices described above and/or below, which are offset from one another in the transverse direction. The soil tillage devices are in particular arranged on a machine frame of the agricultural machine so as to be movable in a direction perpendicular to the transverse direction. The machine is in particular a multi-row single-seed seeder for beets.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows an agricultural machine according to an example embodiment of the invention in a perspective view.

FIG. 2 shows an example embodiment of an agricultural machine in a front view.

FIG. 3 shows an example embodiment of an agricultural machine in a rear view.

FIG. 4 shows an example embodiment of a soil tillage device of the agricultural machine according to the invention in a side view.

FIG. 5 shows an example embodiment of a soil tillage device in a perspective view.

FIG. 6 shows a side view of an example embodiment of a part of the soil tillage device.

FIG. 7 shows a side view according to FIG. 6 without illustration of fastening elements and cover elements.

FIG. 8 shows a side view according to FIG. 6 without illustration of fastening elements and of the coulter unit.

FIG. 9 shows a side view according to FIG. 8 without illustration of a second cover element.

FIG. 10 shows a long script by the soil tillage device.

FIG. 11 shows a section through the soil tillage device along a plane in which the recess center axes lie.

### DETAILED DESCRIPTION OF THE DRAWINGS

Parts that are identical or have the same function are marked with the same reference numbers, where appropriate. The individual technical features of the embodiments described below can also lead to further developments according to the invention when combined differently than described.

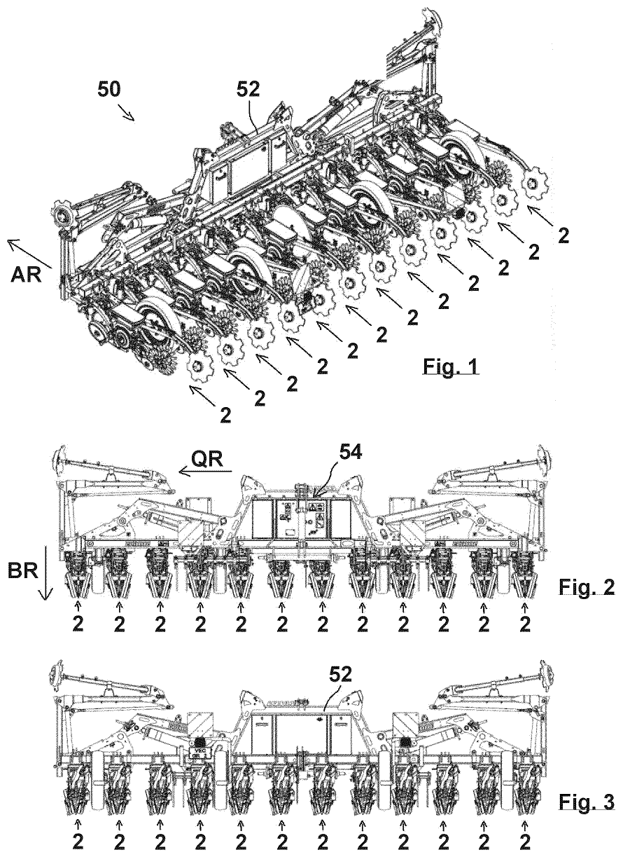

The agricultural machine 50 according to FIGS. 1 to 3 is to be attached to an agricultural tractor (not shown) via a coupling device 54. During operation, the machine 50 is moved in a working direction AR. The machine 50 comprises a machine frame 52 and twelve soil tillage devices 2. The soil tillage devices 2 are arranged in a row on the machine frame 52 in a transverse direction QR at right angles to the working direction AR. Relative to the machine frame 52, the soil tillage devices 2 are individually movable in a vertical direction BR.

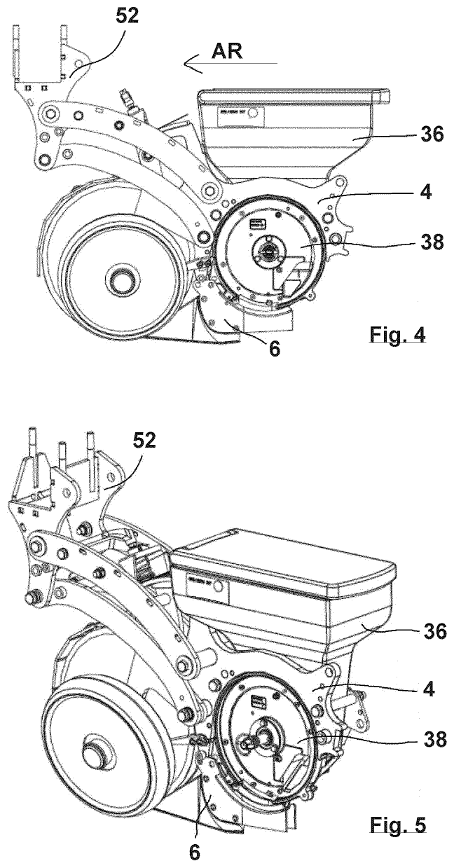

The structure of the individual soil tillage devices 2 is illustrated in FIGS. 4 and 5. Each soil tillage device 2 comprises a frame device 4 and a sowing device with a container 36 for storing seeds. In addition, the sowing device comprises a singling device 38 for singling the seeds and depositing them in a furrow. A coulter unit 6 is used to create the furrow during operation.

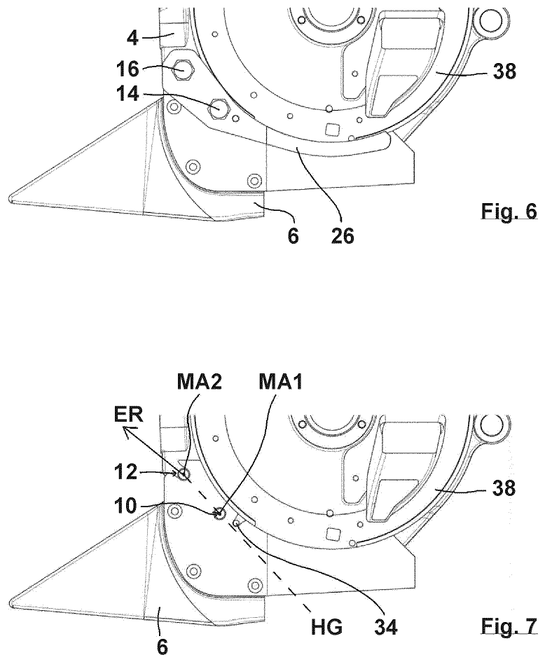

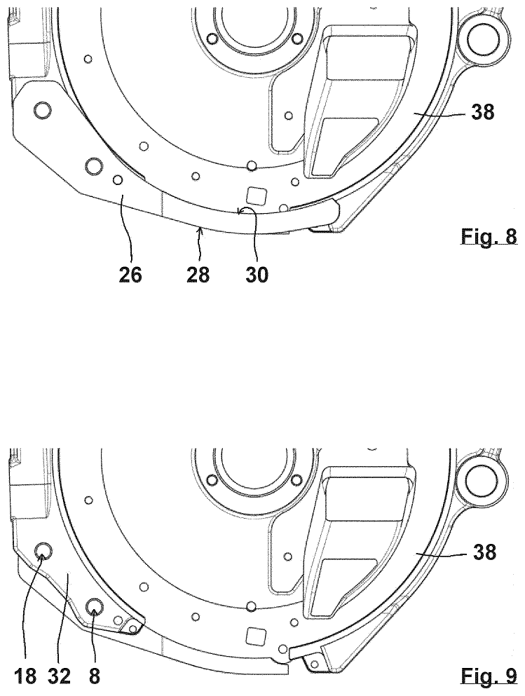

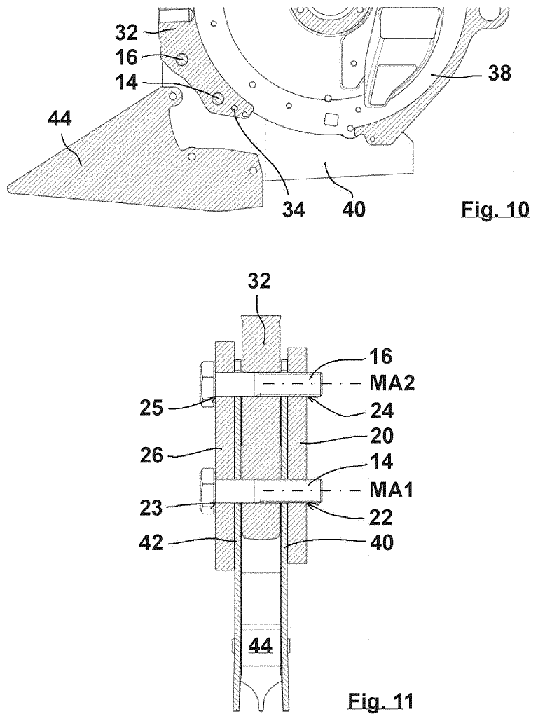

The coulter unit 6 is detachably fastened to the frame device 4. The coulter unit 6 comprises a central coulter body 44 and two sheet metal elements 40, 42, between which a frame element 32 of the frame device 4 is arranged (cf. FIGS. 10 and 11). The coulter unit 6 has a first recess 10 and a second recess 12. The frame device 4 also has a first recess 8 and a second recess 18. All of these recesses 8, 10, 12, 18 are designed continuously in the transverse direction QR. The first recesses 8, 10 are aligned around a first recess center axis MA1. The second recesses 12, 18 are aligned around a second recess center axis MA2 (cf. FIGS. 7 and 9).

The second recess 12 of the coulter unit 6 is open outwards in the side view according to FIG. 7 in an insertion direction ER. The insertion direction ER is angled to a tangential direction TR, which is oriented at right angles to an auxiliary straight line HG which runs through the two recess center axes MA1, MA2. Specifically, the insertion direction ER is angled by an angle a of at least 70° to the tangential direction TR in the side view. The insertion direction ER is away from the first recess center axis MA1. The second recesses 12, 18 are arranged in front of the first recesses 8, 10 relative to the working direction AR and behind the first recesses 8, 10 relative to the direction BR.

A first fastening element 14 in the form of a screw extends through the first recesses 8, 10. A second fastening element 16 in the form of a screw extends through the second recesses 12, 18 (cf. FIG. 6). The fastening elements 14, 16 extend into a first recess 22 and a second recess 24, respectively, which each have an internal thread, of a first cover element 20. The first cover element 20 is arranged to the right of the coulter unit 6 when viewed in the working direction. A second cover element 26 is arranged opposite the first cover element 20. The second cover element 26 also has a first recess 23 and a second recess 25 through which the fastening elements 14, 16 extend. Both cover elements 20, 26 have both an arcuate underside and an arcuate upper side (cf. FIG. 8). The frame device 4 comprises a retaining element 34, which is in a force-fitting, immovable manner arranged in the frame element 32 and extends into the first cover element 20 and the second cover element 26, wherein the cover elements 20, 26 are movable relative to the retaining element 34 in the transverse direction QR.

1. A soil tillage device comprising:
a frame device; and
a coulter unit detachably attached to the frame device wherein during operation, the coulter unit is moved through the ground in a working direction (AR) to create a furrow,
wherein the frame device and the coulter unit each have at least one first recess extending in a transverse direction (QR) angled to the working direction (AR),
wherein one of the at least one first recess of the frame device is aligned with one of the at least one first recess of the coulter unit about a first recess center axis (MA1),
wherein a first fastening element extends through the one of the at least one first recess of the frame device and the one of the at least one first recess of the coulter unit,
wherein the frame device or the coulter unit has at least one second recess extending in the transverse direction (QR) with a second recess center axis (MA2), through which a second fastening element extends and which is formed open to the outside in a longitudinal section in an insertion direction (ER),
wherein in the longitudinal section, the insertion direction (ER) is angled to a tangential direction (TR) which is oriented at right angles to an auxiliary straight line (HG) through the two recess center axes (MA1, MA2).

2. The soil tillage device according to claim 1, wherein the insertion direction (ER) is at least partially directed away from the first recess center axis (MA1).

3. The soil tillage device according to claim 1, wherein the second recess is arranged in front of the one of the at least one first recess of the frame device and the one of the at least one first recess of the coulter unit with respect to the working direction (AR).

4. The soil tillage device according to claim 1, wherein in the longitudinal section, the insertion direction (ER) is angled by an angle (a) to the tangential direction (TR) which is at least 30°.

5. The soil tillage device according to claim 1, wherein the first fastening element is a screw.

6. The soil tillage device according to claim 1, wherein the coulter unit or the frame device has a second recess which is aligned with the second recess of the other of the frame device or coulter unit around the second recess center axis (MA2) and which is continuous in the transverse direction (QR).

7. The soil tillage device according to claim 1, wherein the second fastening element is movable in the transverse direction (QR) relative to the coulter unit and relative to the frame device.

8. The soil tillage device according to claim 7, wherein the frame device comprises a one-piece frame element in which the first recess of the frame device and the second recess of the frame device are positioned.

9. The soil tillage device according to claim 1, further comprising a first cover element which bears laterally against the coulter unit or the frame device and has a first recess into or through which the first fastening element extends, and a second recess into or through which the second fastening element extends.

10. The soil tillage device according to claim 9, wherein the first recess and the second recess of the first cover element each have an internal thread.

11. The soil tillage device according to claim 9, further comprising a second cover element located opposite the first cover element and rests laterally on the coulter unit or the frame device and has a first recess through which the first fastening element extends, and a second recess through which the second fastening element extends.

12. The soil tillage device according to claim 11, wherein at least one of the first cover element or the second cover element has, in a side view, a substantially arcuate underside and/or a substantially arcuate upper side.

13. The soil tillage device according to claim 11, further comprising a retaining element surrounded by the frame device, which extends in or through a frame element of the frame device, and in or through the first cover element and/or the second cover element, wherein the retaining element is stationary relative to the frame element and movable at least in the transverse direction (QR) relative to the cover elements.

14. The soil tillage device according to claim 1, further comprising a sowing device comprising a container for storing seeds, and
a singling device for singling the seeds and for depositing the seeds in the furrow.

15. An agricultural machine with a machine frame on which a plurality of soil tillage devices according to claim 1 are arranged offset relative to one another in the transverse direction (QR), and which are moveable in at least one direction (BR) perpendicular to the transverse direction (QR).

16. The soil tillage device according to claim 7, wherein the second fastening element is a screw.

17. The soil tillage device according to claim 8, wherein the one-piece frame element is a cast part.

18. The soil tillage device according to claim 13, wherein the retaining element is a cast part.
